(19) United States
(12) Patent Application Publication
(10) Pub. No.: US 2006/0232759 A1
(43) Pub. Date: Oct. 19, 2006

(54) Image forming apparatus for improving image quality

(76) Inventors: Noriaki Fukube, Kawasaki city (JP); So Ohta, Tokyo (JP); Tetsuya Ofuchi, Tokyo (JP)

Correspondence Address: HARNESS, DICKEY & PIERCE, P.L.C., P.O. BOX 8910, RESTON, VA, 20195, US

(21) Appl. No.: 11/406,377

(22) Filed: Apr. 19, 2006

(30) Foreign Application Priority Data
Apr. 19, 2005 (JP) 2005-121149
Jun. 22, 2005 (JP) 2005-182657
Jun. 22, 2005 (JP) 2005-182658
Jun. 22, 2005 (JP) 2005-182659

(51) Int. Cl. G03B 27/00

(52) U.S. Cl. 355/408

(57) ABSTRACT

An image forming apparatus includes a sheet feed unit having a sheet feed port, an image forming unit, a sheet position detector, a mode selector, and a memory unit. The sheet feed unit feeds a recording sheet. The image forming unit forms an image on the recording sheet. The sheet position detector detects a sheet edge of the recording sheet. The mode selector selects at least one of the position correction mode and non-correction mode for the sheet feed port. An image forming position on the recording sheet is corrected using position information detected by the sheet position detector when the position correction mode is selected, and the image forming position on the recording sheet is not corrected when the non-correction mode is selected. A memory unit may store a plurality of values of light intensity and threshold value corresponding to different types of recording sheets.

### TECHNICAL FIELD

Example embodiments of the present invention generally relate to an image forming apparatus having a sheet feed unit and image forming unit, and more particularly to an image forming apparatus, which detects a sheet position and corrects an image forming position on a recording sheet using information of the sheet position.

### BACKGROUND

An image forming apparatus, for example, a printer, a copier, or a facsimile may include a sheet feed unit and a sheet position detector.

When a recording sheet is transported along a sheet transport route of the image forming apparatus, the sheet position detector detects a position of an edge of the recording sheet.

Based on information regarding the sheet edge of the recording sheet, an image forming position on the recording sheet may be corrected (or adjusted) in the image forming apparatus.

If such correction (or adjustment) is not conducted, an image forming position on the recording sheet may deviate from a desired or predetermined position, and image quality may be downgraded.

Such a sheet position detector may include a sensor array having a straight-line configuration, for example. The sensor array may be arranged in a direction perpendicular to a transport direction of the recording sheet. The sensor array may include light emitting elements and light receiving elements, for example.

In such a sheet position detector, the light emitting elements and light receiving elements may be arranged in a parallel manner or the light emitting elements and light receiving elements may be arranged in opposing positions, in which the light emitting elements and light receiving elements face each other with a desired or predetermined space between the light emitting elements and light receiving elements.

The sheet position detector detects a sheet edge of a recording sheet by sensing a light intensity of a reflected light when the light emitting elements and light receiving elements are arranged in a parallel manner, or the sheet position detector detects a sheet edge of a recording sheet by sensing a light intensity of a transmitted light when the light emitting elements and light receiving elements are arranged in opposing positions, in which the light emitted from the light emitting elements pass or does not pass through the recording sheet (e.g. the light is blocked or not by the recording sheet).

In an image forming apparatus, a document position and sheet position may deviate from a desired or predetermined position for several reasons. If such a positional deviation occurs, an image forming condition may be corrected (or adjusted) so that a document image may be more precisely printed at a desired or predetermined position on the recording sheet.

To more precisely detect a sheet position, a sheet position detector may include a larger number of light receiving elements per unit length. In other words, the light receiving elements may have a smaller pitch therebetween.

However, such a configuration increases manufacturing cost of the sheet position detector and image forming apparatus because of the increased number of light emitting and receiving elements.

Although it may be preferable to use a larger number of light emitting and receiving elements to more precisely a detect sheet position, it is preferable to use a smaller number of light emitting and receiving elements to reduce manufacturing cost.

In recent years, due to print speed improvements, image forming apparatuses have been used more frequently in the printing industry.

In the printing industry, print image precision may be an important consideration.

For example, when binding or saddle-stitching a book, a larger volume of recording sheets is cut at once. Therefore, if the image forming position on the recording sheets deviate from correct positions, a finished book may have a quality problem, for example, image drop or too much blank area.

### SUMMARY

Example embodiments of the present invention relate to an image forming apparatus, which includes a sheet feed unit having a sheet feed port, an image forming unit, a sheet position detector, and a mode selector. The sheet feed unit feeds a recording sheet. The image forming unit forms an image on the recording sheet. The sheet position detector detects a sheet edge of the recording sheet. The mode selector selects at least one of a position correction mode and a non-correction mode for the sheet feed port. An image forming position on the recording sheet is corrected using position information detected by the sheet position detector when the position correction mode is selected, and an image forming position on the recording sheet is not corrected when the non-correction mode is selected.

Example embodiments of the present invention relate to an image forming apparatus, which includes a sheet position detector and a memory unit. The sheet position detector for detecting a sheet edge of a recording sheet includes a light emitting unit and a light receiving unit. The light emitting unit may have at least one light emitting element which emits a light to the recording sheet, and the light receiving unit may have a plurality of light receiving elements, for example, arranged in a straight line with an equal pitch, to receive the light from the recording sheet. The memory unit may store a plurality of light intensity values of the light emitting unit and a threshold value for an output signal of the light receiving unit. The light intensity value and threshold value may correspond to different types of recording sheets. The sheet edge of the recording sheet may be detected by using the light intensity and the threshold value stored in the memory unit.

### BRIEF DESCRIPTION OF THE DRAWINGS

A more complete appreciation of the disclosure and many of the attendant advantages and/or features thereof may be readily obtained and understood from the following detailed description with reference to the accompanying drawings, wherein:

FIG. 1 is a schematic view of an image forming apparatus according to an example embodiment;

FIG. 2 is a schematic view of a sheet position detector of transmissive type according to an example embodiment;

FIGS. 3A and 3B are schematic views of a sheet position detector of reflection type according to an example embodiment;

FIG. 4 is a schematic view of a relationship of an optical writing unit and a sheet position detector according to an example embodiment;

FIG. 5 is a timing chart illustrating a writing timing in a main scanning direction when an image forming is conducted by correcting an image forming position according to an example embodiment;

FIG. 6 is schematic view of a relationship of a light receiving unit in a sheet position detector and a recording sheet according to an example embodiment;

FIG. 7 is a schematic display view for selecting a position correction mode, in which an image forming condition may be selected for each sheet feed port according to an example embodiment;

FIG. 8 is a flow chart for explaining a process of selecting an image quality mode according to an example embodiment;

FIG. 9 is a schematic display view for selecting an image quality mode according to an example embodiment;

FIG. 10 is a schematic display view when a manual feed port is selected, in which a correction of image forming position is automatically set according to an example embodiment;

FIG. 11 is another schematic display view when a manual feed port is selected, in which a correction of image forming position is selectable according to an example embodiment;

FIG. 12 is a schematic view of another arrangement for a sheet position detector in an image forming apparatus according to an example embodiment according to an example embodiment;

FIG. 13 is an output signal profile of a sheet position detector of transmissive type according to an example embodiment;

FIG. 14 is an output signal profile of a sheet position detector of reflection type according to an example embodiment;

FIG. 15 is a table storing light intensity, threshold value, and adjusting value for different types of recording sheets according to an example embodiment; and

FIG. 16 is a schematic display view for selecting a type of recording sheet according to an example embodiment.

### DETAILED DESCRIPTION OF EXAMPLE EMBODIMENTS

In describing example embodiments shown in the drawings, specific terminology is employed for the sake of clarity. However, the disclosure of this present invention is not intended to be limited to the specific terminology so selected and it is to be understood that each specific element includes all technical equivalents that operate in a similar manner.

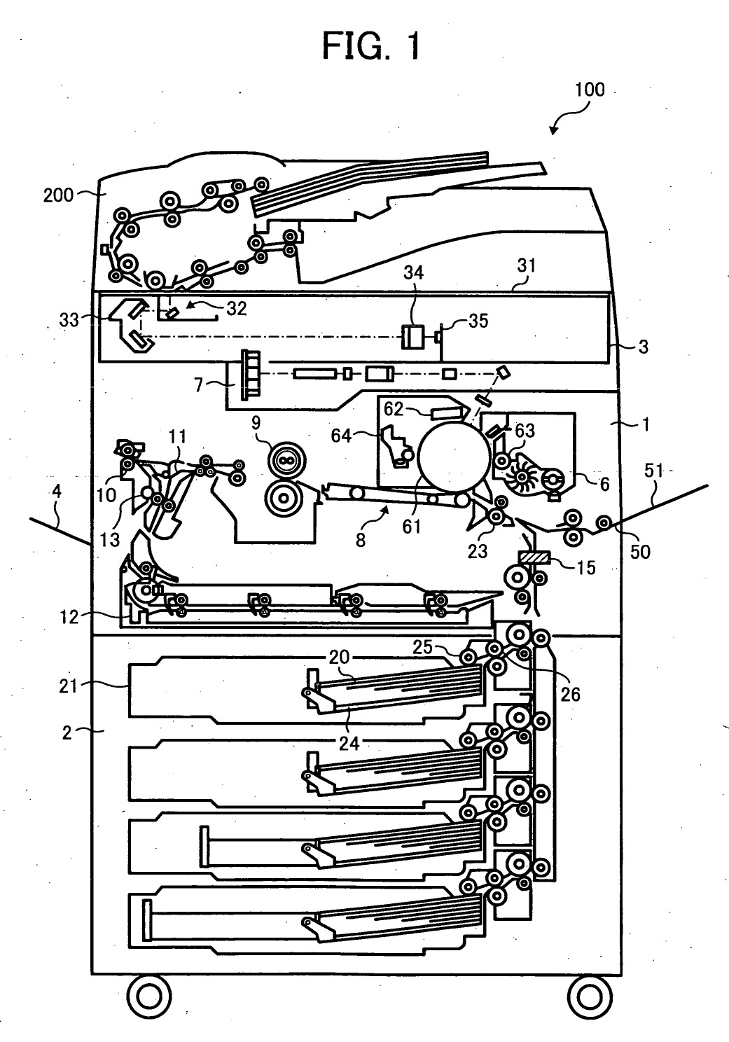

Referring now to the drawings, wherein like reference numerals designate identical or corresponding parts throughout the several views, an image forming apparatus according to an example embodiment is described with a particular reference to FIG. 1.

FIG. 1 is a schematic view of an image forming apparatus 100 according to an example embodiment.

The image forming apparatus 100 may include an image forming section 1, a sheet unit section 2, a scanning unit 3, a sheet ejection tray 4, an image forming unit 6, an optical writing unit 7, a transfer unit 8, and/or a fixing unit 9.

As shown in FIG. 1, the image forming section 1 may be provided in a middle portion of the image forming apparatus 100, and the sheet unit section 2 may be provided under the image forming section 1.

The sheet unit section 2 may include a plurality of sheet trays 21 to store recording sheets as shown in FIG. 1.

The scanning unit 3, which scans documents, may be provided above the image forming section 1 as shown in FIG. 1.

The optical writing unit 7 writes a latent image on a photoconductive member 61 to be described later.

The scanning unit 3 includes a light source 32 and a mirror 33, which may move in the scanning unit 3 to scan a document placed on a contact glass 31. Image information scanned by the scanning unit 3 is focused on a CCD (charge coupled device) 35 via a lens 34 as image signal. Such image signal may be digitally processed by an image processor (not shown).

In the image forming section 1, based on the image signal processed by the image processor, a laser diode (not shown) in the optical writing unit 7 emits a laser beam onto the surface of the photoconductive member 61 to write a latent image on a surface of the photoconductive member 61. The laser beam emitted from the laser reaches the photoconductive member 61 via a polygon mirror and lenses as shown in FIG. 1.

The sheet ejection tray 4 may be provided next to the image forming section 1 to receive a recording sheet having an image thereon, which is ejected from the image forming section 1.

The image forming unit 6 may include a photoconductive member 61, a charger 62, a developing unit 63, and a cleaning unit 64. The photoconductive member 61 may have a drum shape, for example. The charger 62 charges a surface of the photoconductive member 61 uniformly.

The optical writing unit 7 scans a surface of the photoconductive member 61 to write a latent image on the surface of the photoconductive member 61 with a laser beam, generated from the image signal read by the scanning unit 3. The developing unit 63 develops the latent image formed on the surface of the photoconductive member 61 as a toner image. The cleaning unit 64 removes and collects toner remaining on the photoconductive member 61 after the toner image is transferred to a recording sheet from the photoconductive member 61.

The transfer unit 8 transfers the toner image formed on the photoconductive member 61 to the recording sheet. The fixing unit 9 fixes the toner image on the recording sheet.

After the toner image is fixed on the recording sheet by the fixing unit 9, the recording sheet is ejected to the sheet ejection tray 4 by a first ejection roller 10.

The recording sheet is transported to a registration roller 23 before the recording sheet is fed to an image transfer position defined by the transfer unit 8 and the photoconductive member 61. At the registration roller 23, a skew of the recording sheet may be corrected.

When conducting a double-sided printing in the image forming apparatus 100, the recording sheet is introduced into a branching section 11 after transferring the toner image on one face of the recording sheet. The branching section 11 includes an inverting unit 12, in which the face of the recording sheet is inverted. After inverting the recording sheet in the inverting unit 12, the recording sheet is transported to the registration roller 23 again, and the skew of the recording sheet is corrected at the registration roller 23. Then another image is formed on another face of the recording sheet.

In the sheet unit section 2, the sheet tray 21 stores a recording sheet 20, and a bottom plate 24 may pivotably move in an upward direction so that an uppermost recording sheet in the sheet tray 21 may contact a pickup roller 25.

With an effect of rotation of a sheet feed roller 26, the uppermost recording sheet in the sheet tray 21 may be transported to the registration roller 23.

The registration roller 23 stops movement of the recording sheet 20 temporarily, and restarts its rotation with a desired or predetermined timing to feed the recording sheet 20 to the transfer position defined by the transfer unit 8 and the photoconductive member 61.

With such control, the toner image on the photoconductive member 61 may be transferred to a desired or predetermined position on the recording sheet 20.

The image forming apparatus 100 may also include an automatic document feeder 200 over the scanning unit 3. The automatic document feeder 200 may feed documents automatically.

As explained above, the image forming apparatus 100 may be used as digital copier, for example.

Furthermore, the image forming apparatus 100 may be used as a facsimile machine, which may remotely send and receive image information of documents under control of a controller, and may also be used as a printer, which may produce an image on a recording sheet. Therefore, the image forming apparatus 100 may perform a plurality of functions. When the image forming apparatus 100 is used as copier, a user may set conditions for copying.

As mentioned above, a recording sheet having an image thereon may be ejected to the sheet ejection tray 4 by the first ejection roller 10, and stacked on the sheet ejection tray 4.

As mentioned above, when performing double-sided printing in the image forming apparatus 100, a recording sheet is introduced into the branching section 11 having the inverting unit 12. After forming images on both faces of the recording sheet, the recording sheet is ejected to the sheet ejection tray 4 by a second ejection roller 13, and stacked on the sheet ejection tray 4.

Accordingly, recording sheets having images thereon may be stacked on the sheet ejection tray 4 by facing a first sheet of the recording sheets on the surface of the sheet ejection tray 4.

With such stacking, the first sheet of the recording sheets may be collated as a first sheet of the stacked sheets on the sheet ejection tray 4 when documents are processed from page 1 by a copier, facsimile, or printer. Therefore, a user does not need to collate the recording sheets manually.

In the image forming apparatus 100 according to an example embodiment, an image forming position on the recording sheet may be corrected (or adjusted) so that an image may be produced on a desired or predetermined area (or position) of the recording sheet.

As shown in FIG. 1, the image forming apparatus 100 may include a sheet position detector 15.

The sheet position detector 15 may be provided upstream of a sheet transport route in the image forming section 1. For example, the sheet position detector 15 may be provided at a position, which is upstream of the registration roller 23 in a sheet transport route as shown in FIG. 1.

The sheet position detector 15 may detect a sheet edge of the recording sheet. For example, the sheet position detector 15 may detect the sheet edge, which is perpendicular to a transport direction of the recording sheet.

Based on the information detected by the sheet position detector 15, an image forming position on the recording sheet may be corrected (adjusted) in the image forming section 1.

Hereinafter, the sheet position detector 15 is explained with reference to the drawings.

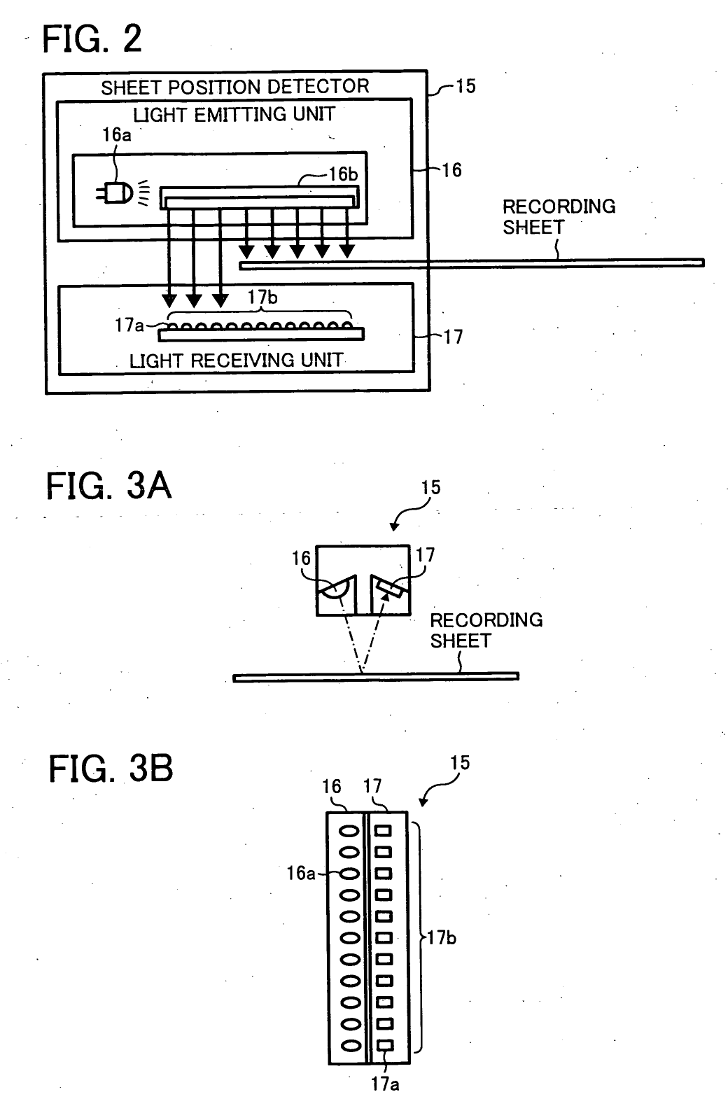

As shown in FIGS. 2 and 3, the sheet position detector 15 may include a light emitting unit 16 and a light receiving unit 17.

The light emitting unit 16 may include at least one light emitting element 16a.

The light receiving unit 17 may include a plurality of light receiving elements 17a, which may be arranged, for example, at an equal pitch with respect to each other. Such plurality of light receiving elements 17a may form a light receiving element array 17b, as shown in FIGS. 2 and 3.

FIG. 2 shows a transmissive-type sheet position detector 15, which includes the light emitting unit 16 and light receiving unit 17 according to an example embodiment. The light emitting unit 16 includes the light emitting element 16a and a light guide 16b, and the light receiving unit 17 includes the light receiving element array 17b, wherein the light guide 16b guides light from the light emitting element 16a in a direction of the light receiving element array 17b.

FIGS. 3A and 3B show a reflection-type sheet position detector 15, which includes the light emitting unit 16 and light receiving unit 17 according to an example embodiment. The light emitting unit 16 includes a plurality of light emitting elements 16a, and the light receiving unit 17 includes the light receiving element array 17b having a plurality of light receiving elements 17a.

FIG. 3A shows a schematic side view of the reflection-type sheet position detector 15 and a recording sheet, and FIG. 3B shows a schematic bottom view of the reflection-type sheet position detector 15.

The sheet position detector 15 shown in FIGS. 2 and 3 detects a sheet edge of a recording sheet as below.

The light emitting unit 16 emits light, and the light receiving unit 17 receives the light, which passes through the recording sheet as shown in FIG. 2. The light receiving unit 17 receives the light, which reflects from the recording sheet, as shown in FIGS. 3A and 3B.

The light intensity detected by the light receiving unit 17 varies depending on whether the recording sheet is in a light path between the light emitting unit 16 and the light receiving unit 17.

Therefore, the sheet position detector 15 outputs signals having different values depending on presence or absence of the recording sheet in the light path between the light emitting unit 16 and the light receiving unit 17.

A threshold value for output signal of the light receiving unit 17, which is used for determining the presence or absence of a sheet edge of a recording sheet, may be set in advance.

By comparing an actual output signal of the sheet position detector 15 and the threshold value for the sheet edge of the recording sheet, a central processing unit (not shown) may determine whether the sheet edge of the recording sheet is detected or not.

Based on such a process for detecting a sheet position, the image forming apparatus 100 may form an image forming on various kinds of recording sheets, for example, plain paper, thick paper, thin paper, drawing paper, high reflection paper, and low reflection paper.

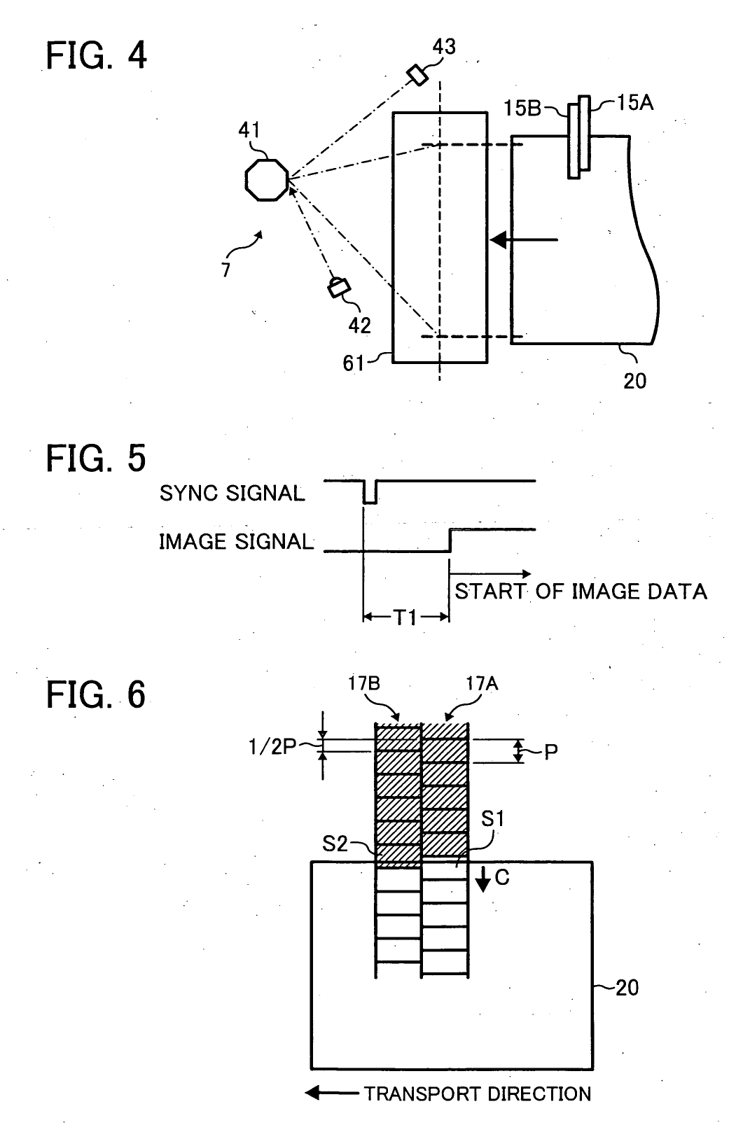

FIG. 4 shows a schematic configuration of the light scanning unit 7 and the sheet position detector 15 according to an example embodiment.

In FIG. 4, two sheet position detectors 15A and 15B may be provided in a direction parallel to an axial direction of the photoconductive member 61. In other words, the sheet position detectors 15A and 15B may be provided in a direction, which is parallel to a main scanning direction of the photoconductive member 61.

The sheet position detectors 15A and 15B each may include light receiving units 17A and 17B shown in FIG. 6. In the light receiving units 17A and 17B, the light receiving elements 17a may be arranged with an element-to-element pitch P as shown in FIG. 6. Hereinafter, the element-to-element pitch P is referred as pitch P.

The sheet position detectors 15A and 15B may have a positional relationship that the sheet position detectors 15A and 15B are shifted or offset with respect to each other, for example, by a length of one-half of the pitch P (e.g., ½ P). Such a positional relationship is explained later with reference to FIG. 6.

The recording sheet 20 stacked in the sheet tray 21 is fed to the image forming section 1 by the pickup roller 25. The recording sheet 20 is fed to the registration roller 23 and stopped temporarily by the registration roller 23 before the recording sheet 20 is fed to the image forming unit 6. The registration roller 23 feeds the recording sheet 20 to the image forming unit 6 with a desired or predetermined timing so that a toner image may be transferred to the recording sheet 20 correctly.

Before the recording sheet 20 is fed to the image forming unit 6, the sheet position detectors 15A and 15B detect the sheet edge of the recording sheet 20, and output signals for the sheet edge of the recording sheet 20.

FIG. 5 shows a timing chart illustrating when to write an image in a main scanning direction of the photoconductive member 61 according to an example embodiment. An image may be written in the main scanning direction of the photoconductive member 61 as described below.

As shown in FIG. 4, the optical writing unit 7 may include a polygon mirror 41, a laser diode 42, and a synchronous signal detector 43. The laser diode 42 emits a laser beam to the polygon mirror 41 to scan the photoconductive member 61 in the main scanning direction of the photoconductive member 61.

For each scan, one synchronous signal is generated, and the synchronous signal detector 43 detects the synchronous signal.

When an interval time T1 has passed after the synchronous signal detector 43 detects the synchronous signal, the optical writing unit 7 starts to write a latent image, corresponding to image data read by the scanning unit 3, on the photoconductive member 61 with the laser beam emitted from the laser diode 42.

By changing the interval time T1 to a longer or shorter time, a write timing of the optical writing unit 7 may be changed to a later or earlier timing.

Accordingly, by changing the interval time T1, an image forming position on the photoconductive member 61 may be corrected (or adjusted).

Furthermore, by computing an interval time T1 based on output signals of the sheet position detectors 15A and 15B, an image forming position on the recording sheet 20 may be corrected (or adjusted).

FIG. 6 shows a schematic view illustrating a positional relationship of the light receiving units 17A and 17B of the sheet position detectors 15A and 15B according to an example embodiment. For the sake of simplifying the explanation, the light emitting unit 16 is omitted from FIG. 6.

In an example embodiment, the sheet position detectors 15A and 15B may be arranged side by side shifted or offset with respect to each other by a length of, for example, one-half of the pitch P (e.g., ½ P), wherein the pitch P is a pitch of light receiving element 17a in the light receiving units 17A and 17B as shown in FIG. 6.

As shown in FIGS. 4 and 6, the reflection-type sheet position detectors 15A and 15B may be arranged in parallel with each other. For the sake of simplifying the drawing, two light receiving units 17A and 17B are schematically illustrated in FIG. 6. Each section of the light receiving units 17A and 17B represents one light receiving element 17a.

When the recording sheet 20 is transported as shown in FIG. 6, the light receiving elements 17a, which are outside of the sheet edge of the recording sheet 20, do not detect light reflected from the recording sheet 20, and the light receiving elements 17a, which are inside the sheet edge of the recording sheet 20, detect light reflected by the recording sheet 20.

In an example, it may be assumed that only one of the light receiving units 17A and 17B is provided in the image forming apparatus 100, for example, only the light receiving unit 17A is provided in the image forming apparatus 100.

If the sheet edge of the recording sheet 20 deviates slightly in a direction shown by an arrow C in FIG. 6, an element S1 in the light receiving unit 17A, which would detect light before the deviation of the recording sheet 20, receives less reflected light after the deviation of the recording sheet 20.

In such a case, a central processing unit (not shown) may determine that the element S1 did not detect reflected light from the recording sheet 20, by which the central processing unit may determine that the sheet edge of the recording sheet 20 may deviate by one pitch P in a direction shown by an arrow C in FIG. 6, although the sheet edge of the recording sheet 20 does not actually deviate by one pitch P.

In an example embodiment, the light receiving unit 17B is provided in addition to the light receiving unit 17A in the image forming apparatus 100 as shown in FIG. 6.

As mentioned above, the light receiving unit 17B is provided next to the light receiving unit 17A and may be shifted or offset by one-half of the pitch P (e.g., ½ P).

In example embodiments, if the sheet edge of the recording sheet 20 deviates a little in a direction shown by an arrow C in FIG. 6, an element S2 in the light receiving unit 17B, which would not detect light before the deviation of the recording sheet 20, still does not detect reflected light after the deviation of the recording sheet 20.

Therefore, based on the information detected by elements S1 and S2, the central processing unit may determine that the recording sheet 20 may deviate by one-half of the pitch P (e.g., ½ P) in a direction shown by an arrow C in FIG. 6.

For example, if the pitch P in the light receiving units 17A and 17B is 1 mm, a position of the recording sheet 20 may be detected with a precision of 0.5 mm increments (e.g., 0.5, 1.0, 1.5 mm).

The smaller the pitch P is, the greater the precision of sheet edge detection, in general. The pitch P may be set by considering a balance between an image quality and manufacturing cost.

In an example embodiment, in order to detect a sheet edge of the recording sheet 20 more precisely, the recording sheet 20 may be transported at a lower speed or stopped when the sheet position detector 15 detects the sheet edge of the recording sheet 20.

However, such speed control of the recording sheet 20 may degrade productivity of the image forming apparatus 100 because the transport speed of the recording sheet 20 becomes slower.

If a memory unit (not shown) is provided in the image forming apparatus 100, such drawbacks of lower productivity of the image forming apparatus 100 may be reduced.

For example, the image forming apparatus 100 may perform a process for correcting an image forming position on recording sheets by detecting a sheet edge of one recording sheet with the sheet position detector 15, and a correction value for correcting the image forming position, obtained by such a process, may be stored in the memory unit. The image forming apparatus 100 may use such a correction value for subsequent image forming operations to correct an image forming position on subsequent recording sheets.

Accordingly, the image forming apparatus 100 may conduct image forming operations by correcting image forming positions on recording sheets without degrading the productivity of the image forming apparatus 100.

A sheet position (e.g., sheet edge) of a recording sheet may deviate from a desired position when the recording sheet is refilled in the sheet tray 21 or when a sheet feed port is changed.

A sheet refill sensor (not shown) may be provided in the image forming apparatus 100 to detect a refilling of recording sheets in the sheet tray 21.

When the sheet refill sensor detects refilling of recording sheets into the sheet tray 21, the image forming apparatus 100 may conduct a process for correcting an image forming position on a first recording sheet by detecting a sheet edge of the first recording sheet, fed from the sheet tray 21, with the sheet position detector 15. In such a way, the image forming apparatus 100 may obtain a correction value for correcting an image forming position on subsequent recording sheets (e.g., second and subsequent recording sheets) to be fed from the sheet tray 21 after the first recording sheet.

Furthermore, the image forming apparatus 100 may conduct such a process when a sheet feed port is changed from one port (e.g., port 1) to another port (e.g., port 2). For example, the image forming apparatus 100 may conduct a process for correcting an image forming position on a first recording sheet fed from another port (e.g., port 2) by detecting a sheet edge of the first recording sheet with a sheet position detector 15. In such a way, the image forming apparatus 100 may obtain a correction value for correcting an image forming position on subsequent recording sheets (e.g., second and subsequent recording sheets) to be fed from another port (e.g., port 2) after the first recording sheet.

Further, sheet refilling may be conducted while the image forming apparatus 100 is powered-off. In this example, the image forming apparatus 100 may be configured to conduct a process for correcting an image forming position on a first recording sheet, which is fed when the image forming apparatus 100 is first turned to power-on from power-off.

Further, the image forming apparatus 100 may conduct a process for correcting an image forming position on a first recording sheet in one print job, and may use a correction value, obtained with the first recording sheet, to correct an image forming position on subsequent recording sheets (e.g., second and subsequent recording sheets) in the same job.

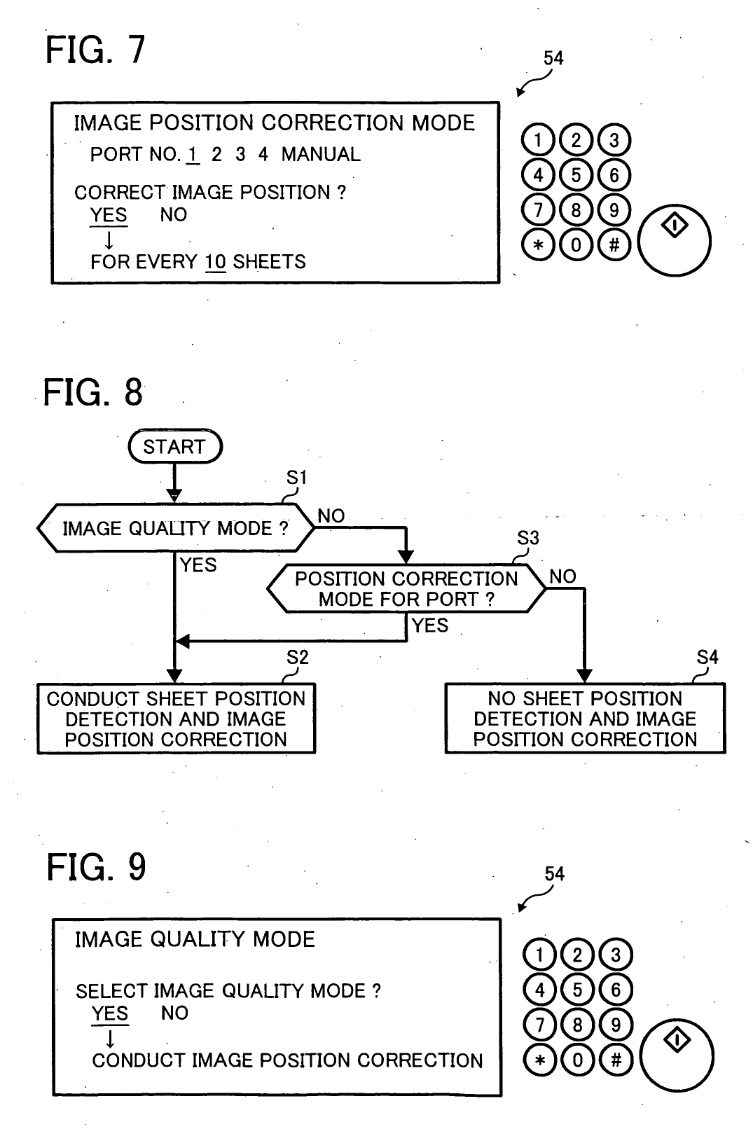

FIG. 7 is a schematic display view for selecting a position correction mode, in which an image forming condition may be selected for each sheet feed port in accordance with an example embodiment.

In an example embodiment, a user may select a position correction mode or non-correction mode for each sheet feed port from a display unit 54 shown in FIG. 7. For example, the user may set a priority on an image quality by selecting the position correction mode, or may set a priority on productivity by selecting the non-correction mode from the display unit 54.

As mentioned above, the display unit 54 may be used to select a mode such as position correction mode and non-correction mode. The display unit 54 may include a touch panel type using a liquid crystal panel, for example.

A mode selected by a user may be stored as flag data in a memory unit (not shown) in the image forming apparatus 100.

When a user designates a position correction mode as flag information for one sheet feed port (e.g., port 1), the image forming apparatus 100 may correct an image forming position on the recording sheets fed from the sheet feed port (e.g., port 1).

Further, a correction frequency of image forming position on recording sheets may be stored in the memory unit (not shown) in addition to the flag information. With information of correction frequency, the image forming apparatus 100 may correct the image forming position on recording sheets.

For example, as shown in FIG. 7, a user may set a correction frequency on the display unit 54 as “every ten (10) sheets” for one sheet feed port (e.g., port 1) so that the image forming apparatus 100 may conduct a correction of image forming position for every ten (10) sheets of recording sheets fed from the one sheet feed port (e.g., port 1).

By setting the correction frequency to a larger value, the user may obtain a desired balance between the image quality and productivity.

Accordingly, a user may set an image forming condition for each sheet feed port individually from a display unit 54 shown in FIG. 7.

Hereinafter, an image quality mode, which may be selected from the display unit 54, is explained.

FIG. 8 is a flow chart for explaining a process of selecting an image quality mode according to an example embodiment, and FIG. 9 is a schematic display view for selecting an image quality mode according to an example embodiment.

When the image quality mode is selected as shown in FIG. 9, the image forming apparatus 100 may detect a sheet position and correct the image forming position on the recording sheet fed from any sheet feed port by disregarding other modes, set to the sheet feed ports. For example, even if a non-correction mode is set to one sheet feed port (e.g. port 1), a user may set a position correction mode to the one sheet feed port (e.g. port 1) by selecting the image quality mode, which may override the non-correction mode.

Hereinafter, a process for selecting the image quality mode shown in FIG. 8 is explained.

At S1, a central processing unit (not shown) determines whether an image quality mode is selected or not.

If the central processing unit determines that the image quality mode is selected at S1, the image forming apparatus 100 detects a sheet position and corrects the image forming position on a recording sheet at S2.

When the process flows from S1 to S2, the image quality mode is selected for all sheet feed ports.

If the central processing unit determines that the image quality mode is not selected at S1, the central processing unit further determines whether a position correction mode is selected for a sheet feed port at S3.

If the central processing unit determines that the position correction mode is selected for the sheet feed port at S3, the image forming apparatus 100 detects the sheet position and corrects the image forming position on the recording sheet at S2.

When the process flows from S1, to S3, to S2, sheet position detection and correction of image forming position on the recording sheet is performed for a sheet feed port selected by a user.

If the central processing unit determines that the position correction mode is not selected for the sheet feed port at S3, the image forming apparatus 100 does not conduct sheet position detection and correction of image forming position on the recording sheet at S4.

When the process flows from S1, to S3, to S4, sheet position detection and correction of image forming position on the recording sheet is not performed for any sheet feed ports.

As mentioned above, the image forming apparatus 100 conducts sheet position detection and correction of image forming position on a recording sheet fed from any sheet feed ports when the image quality mode is selected by disregarding other modes set to the sheet feed ports, whereby the image forming apparatus 100 may improve its usability for sheet position correction function. For example, a user may set the image quality mode to all sheet feed ports with a simple operation on the display unit 54.

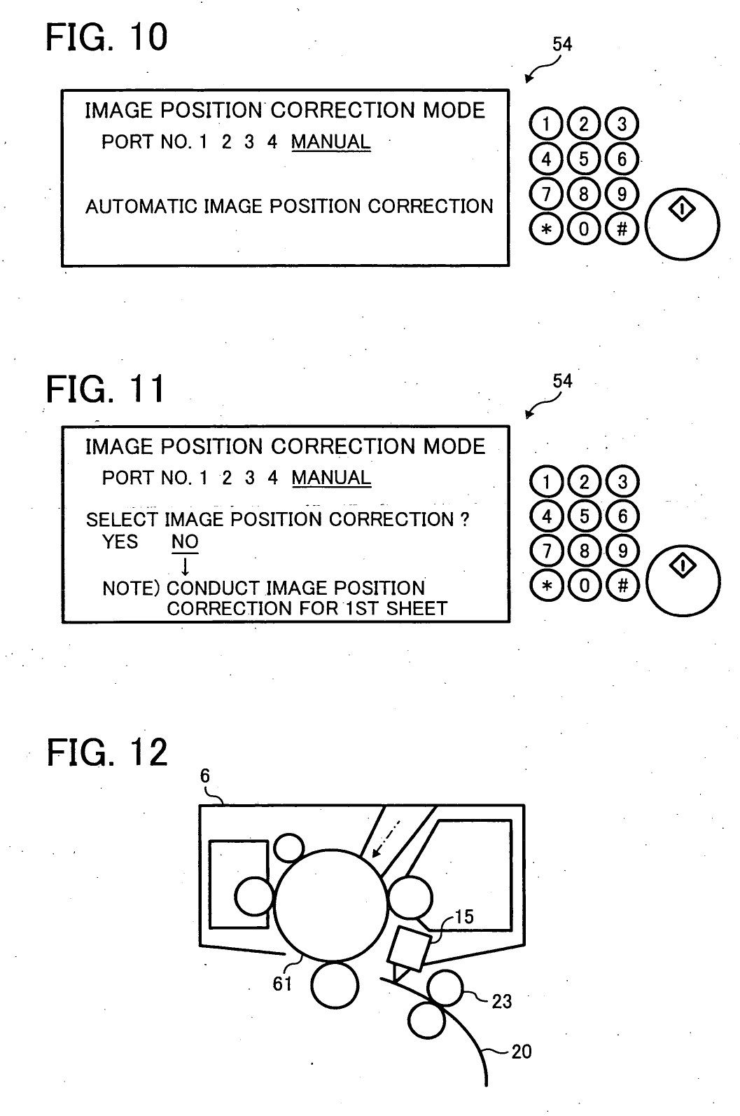

FIG. 10 is a schematic display view when a manual feed port is selected, in which correction of image forming position is automatically selected in accordance with an example embodiment, and FIG. 11 is another schematic display view when a manual feed port is selected, in which correction of image forming position is selectable in accordance with an example embodiment.

As shown in FIG. 1, the image forming apparatus 100 may include a manual feed port 50 and a manual feed tray 51. When recording sheets are placed on the manual feed tray 51, a sheet orientation of the recording sheets may deviate from a correct direction. When the recording sheets are fed from the manual feed tray 51 via the manual feed port 51 to the image forming apparatus 100 under such a condition, the recording sheet is transported in the image forming apparatus 100 with the sheet orientation deviating from the correct direction.

FIGS. 10 and 11 show example methods to address such a drawback.

As shown in FIG. 10, when a user selects the manual feed port 50, a user cannot select a mode for the manual feed port 50. Instead, a correction of image forming position on recording sheets fed from the manual feed port 50 is automatically selected.

Therefore, the image forming apparatus 100 conducts sheet position detection and correction of image forming position on the recording sheets automatically when a user selects the manual feed port 50.

With such control, the image forming apparatus 100 may provide an improved image quality even if the recording sheet is fed from the manual feed port 50.

FIG. 11 is another schematic display view, in which correction of image forming position is selectable for a manual feed port, which is different from FIG. 10.

Even if a user selects not to correct the image forming position on recording sheets fed from the manual feed port 50 as shown in FIG. 11, the image forming apparatus 100 may be configured to conduct sheet position detection and correction of image forming position on at least a first recording sheet fed from the manual feed port 50 to obtain a correction value for correcting an image forming position on the recording sheet to be fed from the manual feed port 50. Such a correction value may be used for correcting an image forming position of subsequent recording sheets (e.g., second and subsequent recording sheets) fed from the manual feed port 50, whereby the image forming apparatus 100 may provide improved image quality, even if recording sheets are fed from the manual feed port 50.

Thus, the image forming apparatus 100 may realize a balance of functionality between image quality and productivity even if the recording sheets is fed from the manual feed port 50 of the manual feed tray 51.

FIG. 12 is a schematic view of another arrangement for the sheet position detector 15 in the image forming apparatus 100 according to an example embodiment.

In FIG. 12, the sheet position detector 15 may be provided downstream of the registration roller 23, which is different from a configuration shown FIG. 1, which shows the sheet position detector 15 upstream of the registration roller 23.

In FIG. 12, the image forming unit 6 may be provided as a process cartridge, which integrally includes the sheet position detector 15.

Except the position of the sheet position detector 15, the image forming unit 6 in FIG. 12 may be similar to the configuration shown in FIG. 1.

In the image forming apparatus 100, a front end of the recording sheet may abut and be stopped by the registration roller 23. At the registration roller 23, a skew of the recording sheet may be corrected, in addition to adjustment of sheet feed timing to the image forming unit 6.

Accordingly, if the sheet position detector 15 is provided upstream of the registration roller 23 as shown in FIG. 1, the sheet position detector 15 detects a sheet position of the recording sheet before a skew correction is conducted for the recording sheet.

If the sheet position detector 15 is provided downstream of the registration roller 23 as shown in FIG. 12, the sheet position detector 15 may detect a sheet position of the recording sheet after a skew correction is conducted for the recording sheet.

Therefore, the sheet position detector 15, provided in the position of FIG. 12, may detect a sheet position of the recording sheet more precisely than the sheet position detector 15 provided in the position of FIG. 1.

If the recording sheet is transported at a slower speed, a flip-flop movement of recording sheet may be reduced. In such a condition, the sheet position detector 15 may detect a sheet position of the recording sheet more precisely.

Further, the sheet position detector 15 may detect the sheet position of the recording sheet more precisely under a condition that the registration roller 23 stops again when a front end of the recording sheet passed the sheet position detector 15 and a rear portion of the recording sheet is still sandwiched by the registration roller 23 as shown in FIG. 12.

Further, a slower speed may be set for transporting a recording sheet when a time is required to read output signals of the light receiving elements 17a of the sheet position detector 15 and to compute an image forming position on the recording sheet based on such output signals. In such a condition, the reading and computing process may be conducted while the recording sheet is transported at a slower speed.

If the recording sheet is transported at a slower speed or stopped temporarily as mentioned above, the image forming apparatus 100 may detect sheet position more precisely; however, the image forming apparatus 100 may have lower productivity if the recording sheet is transported at a slower speed or stopped temporarily.

If a memory unit (not shown) is provided in the image forming apparatus 100, such drawbacks of lower productivity of the image forming apparatus 100 may be reduced.

For example, the image forming apparatus 100 may conduct a correction process for correcting an image forming position on recording sheets by detecting a sheet edge position of one recording sheet with the sheet position detector 15, and a correction value for correcting the image forming position obtained by the correction process may be stored in the memory unit. The image forming apparatus 100 may use such a correction value for subsequent image forming operations to correct an image forming position on the subsequent recording sheets.

Accordingly, the image forming apparatus 100 may conduct image forming operations while correcting image forming positions on recording sheets without degrading the productivity of the image forming apparatus 100.

The above-described operations shown in FIGS. 7 to 11 for the image forming apparatus 100 in FIG. 1 may also be conducted with the image forming apparatus 100 having the configuration shown in FIG. 12.

Furthermore, in another arrangement shown in FIG. 12, the sheet position detector 15 may be integrated with the image forming unit 6 (e.g., process cartridge). If the sheet position detector 15 and image forming unit 6 are integrated, the sheet position detector 15 may be replaced from the image forming apparatus 100 by replacing the image forming unit 6 from the image forming apparatus 100.

Such integral configuration of the sheet position detector 15 and image forming unit 6 may improve maintenance efficiency of the sheet position detector 15.

For example, the maintenance may include replacement of the light emitting element 16a and light receiving elements 17a when such elements are damaged or cleaning the light emitting element 16a and light receiving elements 17a when such elements are contaminated by foreign objects, such as paper powder or toner.

Furthermore, if the light emitting unit 16 and the light receiving unit 17 are separately provided in the image forming apparatus 100, any one of the light emitting unit 16 and light receiving unit 17 maybe integrated with the image forming unit 6.

In an example embodiment, two sheet position detectors 15 may be arranged side by side by shifting two sheet position detectors with one-half of the pitch P (e.g., ½ P) as shown in FIGS. 4 and 6. However, the number of the sheet position detectors 15 may be adjusted to any number.

For example, three sheet position detectors 15 may be arranged side by side by shifting or offsetting three sheet position detectors with one-third of the pitch P (e.g., ⅓ P) with respect to each other, or four sheet position detectors 15 may be arranged side by side by shifting or offsetting four sheet position detectors with one-fourth of the pitch P (e.g., ¼ P) with respect to each other.

By employing such an arrangement for the sheet position detectors 15, the image forming apparatus 100 may conduct sheet position detection more precisely.

In an example embodiment, the sheet position detector 15 includes the light emitting unit 16 having a plurality of light emitting elements 16a and the light receiving unit 17 having a plurality of light receiving elements 17a as shown in FIGS. 3A and 3B.

However, the sheet position detector 15 may be composed of one light emitting element 16a and one light receiving unit 17, which includes a plurality of light receiving elements 17a arranged with equal pitch to reduce manufacturing cost of the sheet position detector 15 by reducing the number of the parts.

The sheet position detector 15 may take another configuration, which is shown in FIG. 2. In FIG. 2, the sheet position detector 15 may include the light emitting unit 16 and the light receiving unit 17, which are separately provided in the sheet position detector 15 while facing each other. In such a configuration, the light receiving unit 17 receives a light, which transmits a recording sheet transported in the image forming apparatus 100. The sheet position detector 15 shown in FIG. 2 may also be used similarly to the sheet position detector 15 shown in FIGS. 3A and 3B.

In an example embodiment, the sheet position is detected when the recording sheet abuts and stops at the registration roller 23 because the sheet position may be detected more precisely when the sheet transportation is stopped. However, the sheet position may also be detected when the recording sheet is transported in the image forming apparatus 100.

In an example embodiment, the image forming apparatus 100 may include a position correction mode and a non-correction mode for an image forming position on the recording sheet, wherein the position correction mode and non-correction mode may be set individually for each sheet feed port. Therefore, a user may select a priority between image quality and productivity for each sheet feed port, and thereby the image forming apparatus 100 may provide a balanced functionality between image quality and productivity.

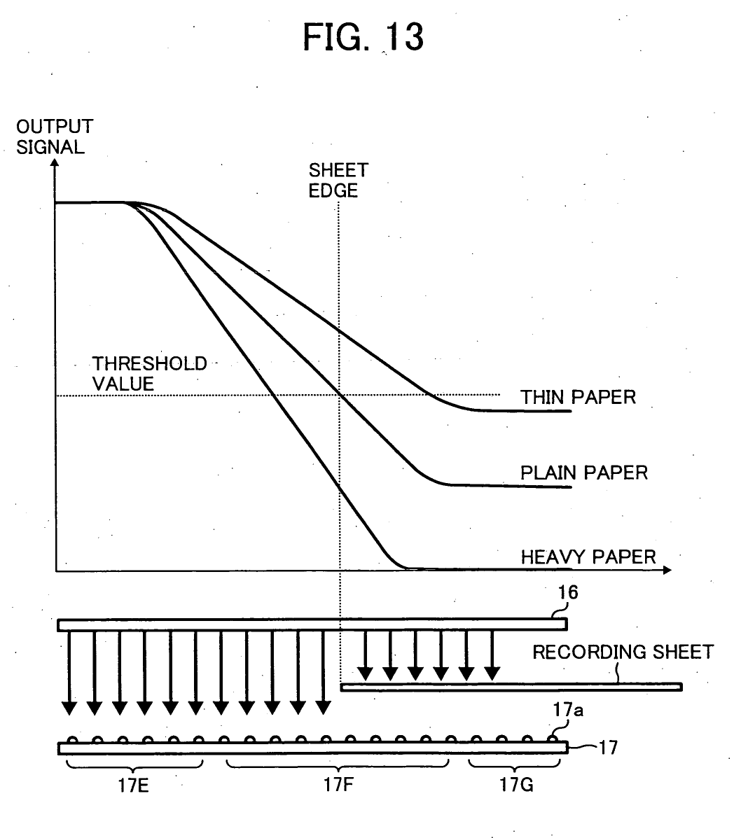

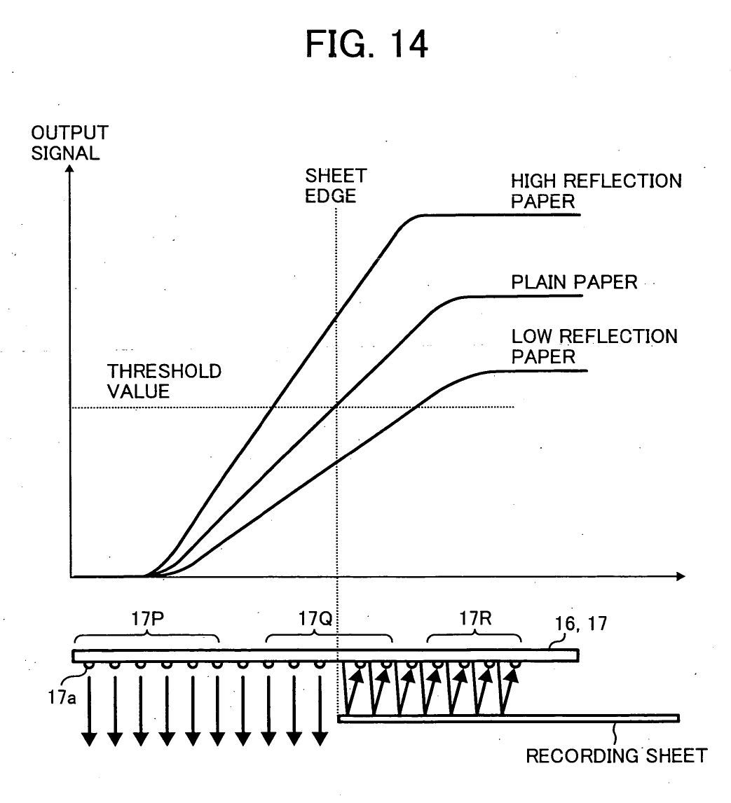

Hereinafter, an output signal profile of the light receiving unit 17 is explained with reference to FIGS. 13 and 14.

FIG. 13 is an output signal profile of the light receiving unit 17 of the transmissive-type sheet position detector 15 of shown in FIG. 2, in which the light receiving element 17a receives a transmitted light.

FIG. 14 is an output signal profile of the light receiving unit 17 of the reflection-type sheet position detector 15 of shown in FIGS. 3A and 3B, in which the light receiving element 17a receives reflected light.

FIGS. 13 and 14 show example output signal profiles in the vicinity of a sheet edge of a recording sheet, which is transported in the image forming apparatus.

In FIGS. 13 and 14, the light emitting unit 16 and the light receiving unit 17 having light receiving elements are schematically illustrated with the output signal profiles.

Hereinafter, the output signal profile of FIG. 13 is explained.

The recording sheet may be at a right side of the sheet edge line shown in FIG. 13. In other words, the recording sheet may not be at a left side of the sheet edge line shown in FIG. 13.

A group of light receiving elements 17a, at a left side of the sheet edge line in FIG. 13, may be referred as light receiving elements 17E for the sake of explanation. The light receiving elements 17E receive light from the light emitting unit 16, and thereby output signals of the light receiving elements 17E may be at a higher level.

The light receiving elements 17a, near the sheet edge line in FIG. 13, are referred as light receiving elements 17F for the sake of explanation. Some of the light receiving elements 17F face the recording sheet, and thereby output signals of the light receiving elements 17F decrease as shown in FIG. 13.

The light receiving elements 17a, at the right side of the sheet edge line, are referred as light receiving elements 17G for the sake of explanation. The light receiving elements 17G face the recording sheet, and thereby output signals of the light receiving elements 17G may be at a lower level.

In the case of plain paper, an output signal of the light receiving element 17a at the sheet edge of the plain paper matches a threshold value for the plain paper, thus the sheet edge of the plain paper may be precisely detected.

In the case of heavy paper, an output signal of the light receiving element 17a becomes a threshold value for the plain paper at a position, which is outside of the sheet edge of the heavy paper as shown in FIG. 13.

In the case of thin paper, an output signal of the light receiving element 17a becomes a threshold value for the plain paper at a position, which is inside of the sheet edge of the thin paper as shown in FIG. 13.

Hereinafter, the output signal profile of FIG. 14 is explained.

The recording sheet may be at a right side of the sheet edge line shown in FIG. 14. In other words, the recording sheet may not be at a left side of the sheet edge line shown in FIG. 14.

The light receiving elements 17a, at the left side of the sheet edge line, are referred as light receiving elements 17P for the sake of explanation. The light receiving elements 17P do not receive a reflected light from the recording sheet, and thereby output signals of the light receiving elements 17P may be at a lower level.

The light receiving elements 17a, near the sheet edge line, are referred as light receiving elements 17Q for the sake of explanation. Some of the light receiving elements 17Q face the recording sheet which reflects the light, and thereby output signals of the light receiving elements 17Q increase as shown in FIG. 14.

The light receiving elements 17a, at the right side of the sheet edge line, are referred as light receiving elements 17R for the sake of explanation. The light receiving elements 17R face the recording sheet, and thereby output signals of the light receiving elements 17R may be at a higher level by receiving reflected light from the recording sheet.

In the case of plain paper, an output signal of the light receiving element 17a at the sheet edge of the plain paper matches a threshold value for the plain paper, thus the sheet edge of the plain paper may be precisely detected.

In the case of high reflection paper, an output signal of the light receiving element 17a becomes a threshold value for the plain paper at a position, which is outside of the sheet edge of the high reflection paper.

In the case of low reflection paper, an output signal of the light receiving element 17a becomes a threshold value for the plain paper at a position, which is inside of the sheet edge of the low reflection paper.

As can be understood from FIGS. 13 and 14, it is difficult to judge a sheet edge of different kinds of sheets with a single light intensity and a single threshold value.

Accordingly, in order to detect a sheet edge of different kinds of recording sheets more precisely, any one of the light intensity of the light emitting element 16a and threshold value for the sheet edge or both of the light intensity of the light emitting element 16a and threshold value for the sheet edge may be changed so that a light intensity of the light emitting element 16a and a threshold value for the sheet edge, corresponding to different kinds of recording sheets, may be set.

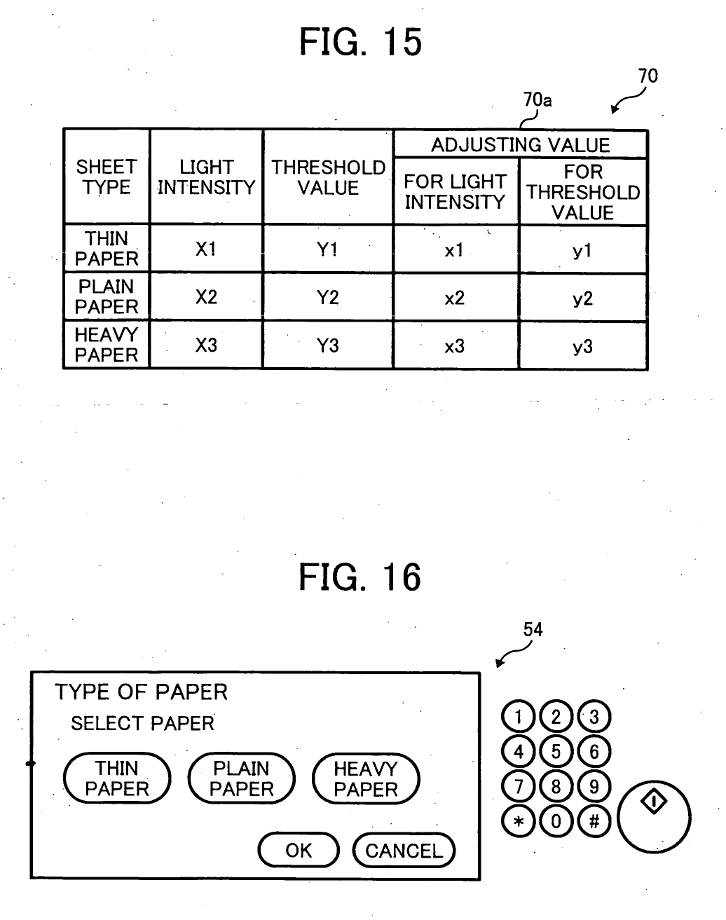

FIG. 15 is a table 70 (e.g., memory unit), which may store a plurality of values of light intensity, threshold value for output signal of the sheet position detector 15, and adjusting values, all of which may correspond to different kinds of recording sheets.

For example, the table 70 (e.g., memory unit) may store a plurality of values of light intensity, threshold value as default values for different kinds of recording sheets, for example, plain paper, heavy paper, thin paper, drawing paper, high reflection paper, and low reflection paper.

Furthermore, the plurality of values of light intensity and threshold value may be adjusted by using an adjusting value 70a, as required.

FIG. 16 is a schematic view of a display view for selecting a type of recording sheet (e.g., thin paper, plain paper, heavy paper) in accordance with an example embodiment.

When a user selects a type of recording sheet, the central processing unit (not shown) selects a light intensity, and threshold value, corresponding to the type of recording sheet selected by the user, from the table 70.

Based on the table 70, the sheet position detector 15 may detect the sheet edge of different types of recording sheets more precisely.

Therefore, the image forming apparatus 100 may correct (or adjust) an image forming position on different types of recording sheets more precisely, by which the image forming apparatus 100 may produce an image on recording sheets with higher quality.

Furthermore, as explained above, the light intensity and threshold value for different types of recording sheets may be adjusted with the adjusting value 70a.

The table 70 stores default values for different types of recording sheets (e.g., plain paper, heavy paper, thin paper, drawing paper), wherein the default values are typical reference values for each type of recording sheet.

Because a user may use various kinds of recording sheets for one type, the adjusting value 70a is provided in the table 70 so that the image forming apparatus 100 may adjust the default value to a suitable value corresponding to a recording sheet used by the user.

With such an adjustment, the image forming apparatus 100 may correct (or adjust) an image forming position on different types of recording sheets more precisely, by which the image forming apparatus 100 may produce an image on recording sheets with higher quality.

Numerous additional modifications and variations are possible in light of the above teachings. It is therefore to be understood that within the scope of the appended claims, the disclosure of the present invention may be practiced otherwise than as specifically described herein.

This application claims priority from Japanese patent applications No. 2005-121149 filed on Apr. 19, 2005, No. 2005-182657 filed on Jun. 22, 2005, No. 2005-182658 filed on Jun. 22, 2005, and No. 2005-182659 filed on Jun. 22, 2005 in the Japan Patent Office, the entire contents of which are hereby incorporated by reference herein.

What is claimed is:

1. An image forming apparatus, comprising:
at least one sheet feed unit having a sheet feed port, the at least one sheet feed unit configured to feed a recording sheet;
an image forming unit configured to form an image on the recording sheet fed from the sheet feed port;
a sheet position detector configured to detect a sheet edge of the recording sheet fed from the sheet feed port; and
a mode selector configured to select at least one of a position correction mode and a non-correction mode for the sheet feed port, wherein an image forming position on the recording sheet is corrected using position information detected by the sheet position detector when the position correction mode is selected, and the image forming position on the recording sheet is not corrected when the non-correction mode is selected.

2. The image forming apparatus according to claim 1, wherein the sheet position detector detects the sheet edge, which is perpendicular to a transport direction of the recording sheet.

3. The image forming apparatus according to claim 1, wherein the sheet position detector comprises:
a light emitting unit including at least one light emitting element configured to emit light toward the recording sheet; and
a light receiving unit, including a plurality of light receiving elements, configured to receive light from the recording sheet.

4. The image forming apparatus according to claim 3, wherein the plurality of light receiving elements are arranged in a straight line with an equal pitch.

5. The image forming apparatus according to claim 3, wherein the light emitting unit and the light receiving unit face each other with a space therebetween, in which the recording sheet is transported when the recording sheet is transported in the sheet position detector.

6. The image forming apparatus according to claim 3, wherein the light emitting unit and the light receiving unit are arranged side by side so that the light emitting unit and the light receiving unit face the recording sheet from one direction when the recording sheet is transported in the sheet position detector.

7. The image forming apparatus according to claim 1, wherein the mode selector is further configured to select an image quality mode, in which correction of an image forming position is automatically conducted on the recording sheet fed from the sheet feed port.

8. The image forming apparatus according to claim 1, further comprising a first manual feed port, to which the position correction mode and the non-correction mode are not selectable, and correction of image forming position on a recording sheet is automatically conducted when the recording sheet is fed from the first manual feed port.

9. The image forming apparatus according to claim 8, further comprising a second manual feed port, to which the position correction mode and the non-correction mode are selectable, and a correction of image forming position on a recording sheet is conducted when the recording sheet is fed from the second manual feed port in the position correction mode.

10. The image forming apparatus according to claim 9, wherein the correction of image forming position is conducted for a first recording sheet fed from the second manual feed port when the non-correction mode is selected for the second manual feed port to obtain a correction value to be used for correcting an image forming position on subsequent recording sheets.

11. An image forming apparatus, comprising:
a sheet position detector configured to detect a sheet edge of a recording sheet, including
a light emitting unit having at least one light emitting element configured to emit light toward the recording sheet; and
a light receiving unit having a plurality of light receiving elements, the light receiving unit configured to receive the light from the recording sheet; and
a memory unit configured to store a plurality of values of light intensity of the light emitting unit and threshold values for output signals of the light receiving unit, each light intensity value and threshold value corresponding to different types of recording sheets,
wherein the sheet edge of the recording sheet is detected using the light intensity and the threshold value stored in the memory unit.

12. The image forming apparatus according to claim 11, wherein the plurality of light receiving elements are arranged in a straight line with an equal pitch.

13. The image forming apparatus according to claim 11, wherein the sheet position detector detects the sheet edge, which is perpendicular to a transport direction of the recording sheet.

14. The image forming apparatus according to claim 11, wherein the light emitting unit and the light receiving unit face each other with a space therebetween, in which the recording sheet is transported when the recording sheet is transported in the sheet position detector.

15. The image forming apparatus according to claim 11, wherein the light emitting unit and the light receiving unit are arranged side by side so that the light emitting unit and the light receiving unit face the recording sheet from one direction when the recording sheet is transported in the sheet position detector.

16. The image forming apparatus according to claim 11, wherein the light intensity of the light emitting unit is adjustable.

17. The image forming apparatus according to claim 11, wherein the threshold value for output signal of the light receiving unit is adjustable.

18. The image forming apparatus according to claim 11, wherein the light intensity of the light emitting unit and the threshold value for output signal of the light receiving unit are adjustable.

19. An image forming apparatus, comprising:
means for feeding a recording sheet;
means for forming an image on the recording sheet fed from the means for feeding;
means for detecting a sheet edge of the recording sheet fed from the means for feeding; and
means for selecting at least one of a position correction mode and a non-correction mode for the means for feeding, wherein an image forming position on the recording sheet is corrected using position information detected by the means for detecting when the position correction mode is selected, and the image forming position on the recording sheet is not corrected when the non-correction mode is selected.
